(19) United States
(12) Patent Application Publication
(10) Pub. No.: US 2005/0094487 A1
(43) Pub. Date: May 5, 2005

(54) Automatic paint stirring equipment

(75) Inventor: Brent Mussatto, Commerce Township, MI (US)

Correspondence Address: GIFFORD, KRASS, GROH, SPRINKLE & CITKOWSKI, P.C, PO BOX 7021, TROY, MI, 48007-7021, US

(73) Assignee: Dedoes Industries, Inc., Walled Lake, MI (US)

(21) Appl. No.: 10/696,803

(22) Filed: Oct. 30, 2003

(51) Int. Cl. B01F 7/20

(52) U.S. Cl. 366/198; 366/247

(57) ABSTRACT

Automatic paint stirring equipment of the type used in automotive finish and repair shops. The equipment includes a rack which is adapted to support a plurality of paint cans. The rack has a plurality of can-receiving stations and each receiving station includes an anti-rotation channel. A drive member is rotatably mounted to each receiving station while a motor mounted to the rack is drivingly connected to the drive members to rotatably drive the drive members in unison with each other. A lid is detachably secured across an open top of each paint can. A stirring assembly is rotatably mounted to the lid and includes a stirrer positioned inside the can, a stirrer shaft secured to the stirrer and rotatably mounted to the lid, and a driven member drivingly connected to the shaft above the lid. An anti-rotation boss extends upwardly from the upper surface of the lid. Upon insertion of the lid with its attached can into the can-receiving station, the drive member drivingly engages the driven member and, simultaneously, the anti-rotation boss is positioned within the anti-rotation channel to prevent rotation of the can about the axis of the stirrer shaft.

### BACKGROUND OF THE INVENTION

I. Field of the Invention

The present invention relates generally to automatic paint stirring equipment.

II. Description of Related Art

Automotive repair and finishing shops and similar businesses typically use automatic paint stirring equipment to ensure that the paint is continuously mixed within its can. Such automatic paint stirring equipment reduces, indeed eliminates, the shop time required to mix the paint. Furthermore, such automatic paint stirring equipment ensures that the paint is properly mixed at all times thus avoiding the undesired ramifications of an improperly or only partially mixed can of paint.

The previously known automatic paint stirring equipment typically comprises a rack having a plurality of can-receiving stations. A drive member is rotatably mounted to each drive station while a motor mounted to the rack rotatably drives the drive members in synchronism with each other.

A lid is then detachably secured to each paint can and each lid includes a stirrer assembly.

The stirrer assembly typically includes a stirrer which is secured to a shaft and the shaft, in turn, is rotatably mounted to the lid so that the stirrer is positioned within the interior of the can. A driven member is then attached to the shaft above the lid so that rotation of the driven member rotatably drives the shaft and stirrer in unison with each other.

Upon insertion of the can with its attached lid into the can-receiving station, the drive member automatically engages the driven member. In doing so, the drive member rotatably drives the stirrer within the interior of the paint can and maintains the paint in a mixed condition.

One problem associated with automatic paint stirring equipment, however, is that due to the force exerted between the stirrer and the paint, the drive member exerts a rotational force on the can which, if unchecked, causes the can to rotate on the rack. Such rotation of the can on the rack is undesirable and renders the subsequent removal of the can from the rack more difficult.

In order to prevent rotation of the paint can relative to the rack, there have been previously known devices to prevent such rotation. In one prior device, a swing down arm from the rack engaged a spout on the paint can to prevent rotation of the can relative to the rack. Such swing down arms, however, not only require assembly, and thus incur labor costs, but also disadvantageously require separate production molds from the other components of the automatic paint stirring equipment.

### SUMMARY OF THE PRESENT INVENTION

The present invention provides automatic paint stirring equipment of the type used in automotive finishing and repair shops which overcomes all of the above-mentioned disadvantages of the previously known devices.

In brief, the paint stirring equipment of the present invention includes a rack which is adapted to support a plurality of paint cans. The rack includes a plurality of can-receiving stations and each receiving station includes an anti-rotation channel.

A drive member is rotatably mounted to the rack at each can-receiving station. A motor mounted to the rack is then drivingly connected to each drive member so that, upon activation of the motor, the motor rotatably drives the drive members in unison with each other.

A lid is detachably secured across an open top of the can. A stirrer assembly includes a stirrer shaft rotatably mounted about a predetermined axis to the lid. A stirrer is secured to one end of the stirrer shaft so that, with the lid positioned on top of the can, the stirrer is positioned within the interior of the can. A driven member complementary to the drive member is then secured to the other end of the shaft so that the driven member is positioned above an upper surface of the lid.

An anti-rotation boss extends upwardly from the upper surface of the lid. This boss is dimensioned so that, upon insertion of the can into a can-receiving station on the rack, the drive member at the can-receiving station drivingly engages the driven member attached to the lid and, simultaneously, the anti-rotation boss is positioned within the anti-rotation channel associated with the rack can-receiving station. The coaction between the channel and the anti-rotation boss prevents rotation of the can about the stirrer shaft axis.

### BRIEF DESCRIPTION OF THE DRAWING

A better understanding of the present invention will be had upon reference to the following detailed description, when read in conjunction with the accompanying drawing, wherein like reference characters refer to like parts throughout the several views, and in which:

FIG. 1 is a fragmentary elevational view of a preferred embodiment of the invention;

FIG. 2 is an elevational view of one lid attached to a can;

FIG. 3 is a top fragmentary view of the invention just prior to insertion of one can with its attached lid into a receiving station; and

FIG. 4 is a view similar to FIG. 3, but illustrating the can with its attached lid after insertion into a receiving station.

### DETAILED DESCRIPTION OF A PREFERRED EMBODIMENT OF THE PRESENT INVENTION

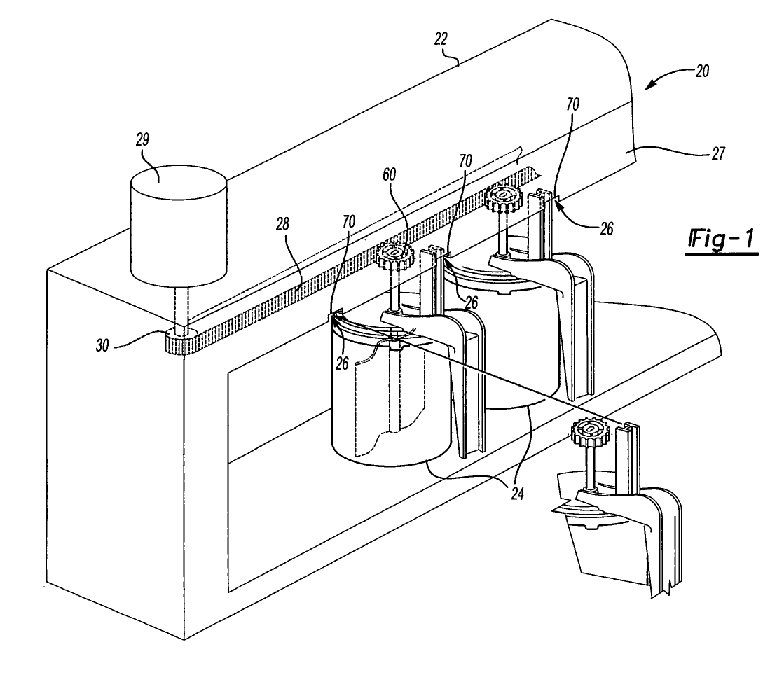

With reference first to FIG. 1, a preferred embodiment of the automatic paint stirring equipment 20 is shown and includes a rack 22 designed to support at least one, and more typically many, paint cans 24. The rack 22 includes at least one and more typically a plurality of predetermined can-receiving stations 26 wherein each receiving station 26 is adapted to removably receive one paint can 24.

A drive belt 28 is mounted to the rack 22 so that the belt 28 registers with each of the receiving stations 26. A motor 29 mounted to the rack 22 is then drivingly connected through any conventional drive mechanism 30 (illustrated only diagrammatically) to the drive belt 28 so that, upon activation of the motor 29, the motor 29 rotatably drives the drive belt 28.

It will be understood that the drive belt 28 is shown for illustration only and that other types of drive members may be employed in lieu of the drive belt without deviation from the spirit or scope of the invention.

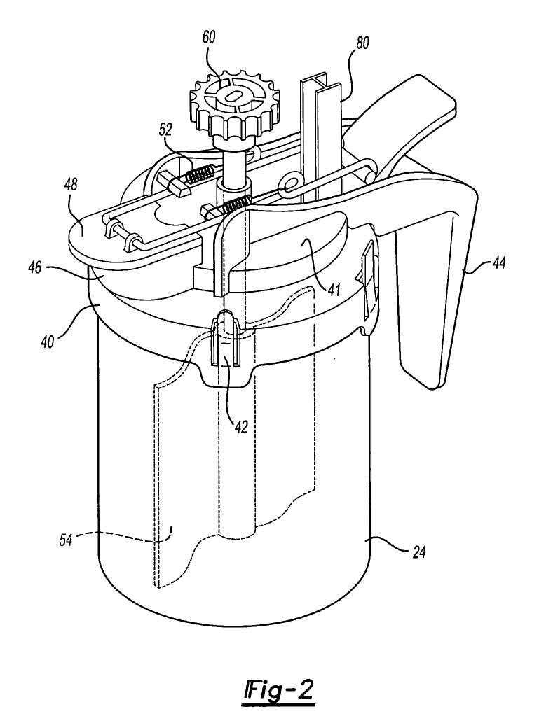

With reference now particularly to FIG. 2, the automatic paint stirring equipment further includes at least one, and more typically a plurality of lids 40. Each lid 40 is adapted to be removably attached across an open top of the paint can 24 so that the lid 40 covers the open top of the paint can. Any conventional means, such as locking feet or snap locks 42, may be used to detachably secure the lid 40 to its associated paint can 24.

Furthermore, in the conventional fashion, the lid 40 typically includes a handle 44 to facilitate manipulation of the lid 40 with its attached can by the user. The lid 40 also includes a spout 46 for dispensing paint from the can 24 as well as a selectively openable closure 48.

Still referring to FIG. 2, a stirrer assembly 50 is associated with each lid 40 and includes a stirrer shaft 52 which is rotatably mounted to the lid 40 about a predetermined vertical axis. A stirrer 54 is attached to the shaft 52 so that, with the lid 40 positioned on its associated paint can 24, the stirrer 54 is positioned within the interior of the paint can 24. A driven member 60 or gear wheel is then attached to the stirrer shaft 52 so that the driven member 60 is positioned above an upper surface 41 of the lid 40. Furthermore, the driven member 60 is configured so that when the driven member 60 and drive belt 28 are aligned with and abutting against each other, the drive belt 28 rotatably drives the driven member 60 with its attached stirrer 54.

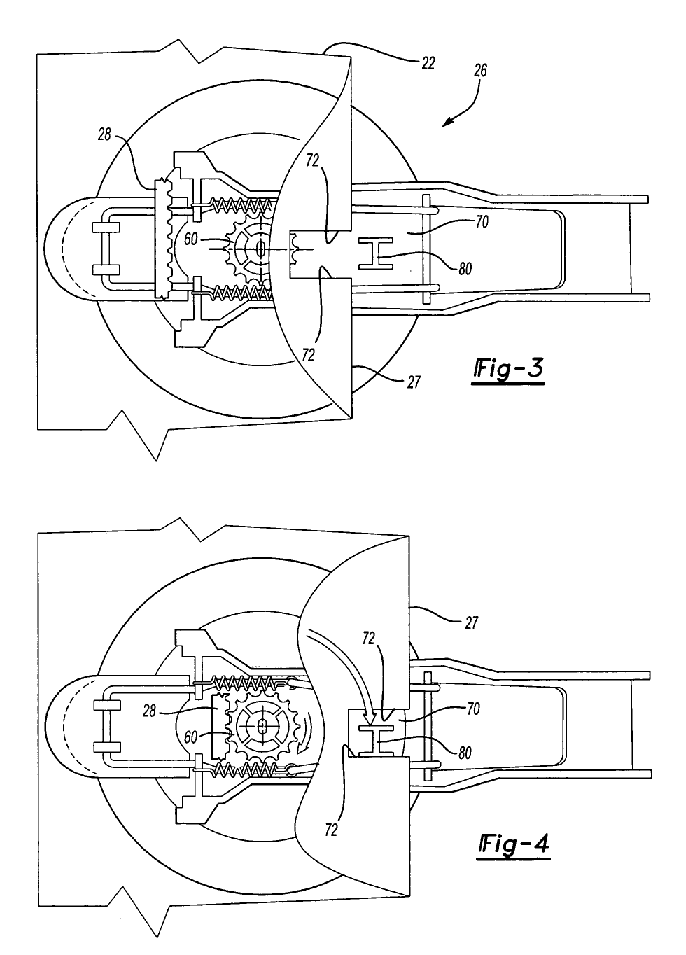

With reference now to FIGS. 1 and 3, each station 26 on the rack 22 includes an anti-rotation channel 70 having spaced apart and generally vertically extending sidewalls 72. Furthermore, the anti-rotation channel 70 at each station 26 opens outwardly towards a front surface 27 of the rack 22.

With reference now particularly to FIG. 2, an anti-rotation boss 80 extends upwardly from the upper surface of the lid 40 and at a position radially spaced from the axis of the stirrer shaft 52. Preferably, the lid 40 is of a plastic construction and the lid 40 and anti-rotation boss 80 are of a one-piece plastic construction. Alternatively, the boss 80 may be a separate component from the remainder of the lid and attached to the lid in any conventional fashion. Furthermore, the boss 80 can alternatively be loosely attached to the paddle shaft or other lid assembly and merely be prevented from rotating relative to the axis of the paddle shaft. Consequently, as used herein, the word “secured” when used to describe the attachment of the boss 80 to the lid shall mean any sort of attachment, direct or indirect, of the boss 80 to the lid sufficient to prevent rotation of the boss 80 around the paddle shaft.

With reference now to FIGS. 3 and 4, in operation, upon insertion of the lid 40 with its attached paint can 24 into one of the receiving stations 26 in the rack 22 from the position shown in FIG. 3 and to the position shown in FIG. 4, the drive belt 28 drivingly engages the driven member 60 so that the motor 29 rotatably drives the stirrer 54 within the can 24 in the desired fashion. Simultaneously upon insertion of the lid 40 with its attached can into the can-receiving station 26 to the position shown in FIG. 4, an upper end 82 of the anti-rotation boss 80 is positioned within the anti-rotation channel 70 between its sidewalls 72. Consequently, the abutment of the anti-rotation boss 80 against the sidewall 72 of the anti-rotation channel 70 prevents rotation of the can 24 about the axis of the stirrer shaft 52.

From the foregoing, it can be seen that the present invention provides automatic paint stirring equipment with a can anti-rotation mechanism which is simple and inexpensive in construction. Having described my invention, however, many modifications thereto will become apparent to those skilled in the art to which it pertains without deviation from the spirit of the invention as defined by the scope of the appended claims.

1. Automatic paint stirring equipment for stirring paint in cans comprising:
a rack adapted to support at least one can, said rack having at least one can receiving station, each of said at least one receiving station having an anti-rotation channel,
a drive member at each of said at least one receiving station,
a motor mounted to said rack and drivingly connected to each said drive member,
a lid detachably secured across an open top of the can,
a stirring assembly having a shaft rotatably mounted around a predetermined axis to said lid, said stirring mechanism having a stirrer secured to said shaft and positioned inside the can and a driven member secured to said shaft and drivingly connected to said stirrer, said driven member extending above an upper surface of said lid,
an anti-rotation boss secured to and extending upwardly from said upper surface of said lid; and
wherein, upon insertion of a can with a secured lid into said at least one receiving station, said drive member drivingly engages said driven member and said anti-rotation boss is positioned in said anti-rotation channel so that co-action between said anti-rotation channel and said anti-rotation boss prevents rotation of said can about said predetermined axis.

2. The invention as defined in claim 1 wherein said anti-rotation boss and said lid are of a one-piece construction.

3. The invention as defined in claim 1 wherein said anti-rotation boss and said lid are of a one-piece plastic construction.

4. The invention as defined in claim 1 wherein said anti-rotation boss is elongated.

5. The invention as defined in claim 4 wherein an axis of said anti-rotation boss is parallel to and radially spaced from an axis of rotation of said shaft.
